(19) United States
(12) Patent Application Publication
(10) Pub. No.: US 2020/0372244 A1
(43) Pub. Date: Nov. 26, 2020

(54) APPARATUS, METHOD AND SW FOR 3D FACE RECOGNITION

(71) Applicant: OP-PALVELUT OY, Helsinki (FI)

(72) Inventors: Aino-Maija TOPPI, Helsinki (FI); Sami KARHUNEN, Helsinki (FI); Aki LIIPO, Helsinki (FI); Thomas O'ROURKE, Helsinki (FI); Michal OLCZAK, Helsinki (FI)

(21) Appl. No.: 16/807,414

(22) Filed: Mar. 3, 2020

(30) Foreign Application Priority Data
May 20, 2019 (FI) 20195414

(51) Int. Cl. G06K 9/00; G06K 9/62

(52) U.S. Cl. CPC G06K 9/00288; G06K 9/6202; G06K 9/00201; G06K 9/00926

(57) ABSTRACT

Apparatus, method and SW for 3D face recognition. The method includes: processing a plurality of initial registrations, each initial registration made by a user, stored in a storage, and including a registration facial image taken with a user apparatus; receiving a current three-dimensional facial image of a current user taken with an authorized three-dimensional camera; searching the plurality of registration facial images for a match with the current three-dimensional facial image based on selected facial features; and if a registration facial image matching with the current three-dimensional facial image is found, confirming the initial registration having the matching registration facial image, and replacing the registration facial image with the current three-dimensional facial image in the storage.

### FIELD

Various embodiments relate to a control apparatus, a method, and computer program code for controlling a three-dimensional face recognition technique for an authentication of a user.

### BACKGROUND

In 3D face recognition technique, a user is identified from a digital image (or a video frame). The identification may be used for an authentication of the user, i.e., confirming the identity of the user. Initial registration for use of the 3D face recognition requires data security and also speed when performed in a service desk accessible by a queue of customers. U.S. Pat. No. 10,268,875 B2 discloses method and apparatus for registering face, and method and apparatus for recognizing face. In said patent, 2D face images are used to generate an individualized 3D facial model.

### BRIEF DESCRIPTION

According to an aspect, there is provided subject matter of independent claims. Dependent claims define some embodiments.

One or more examples of implementations are set forth in more detail in the accompanying drawings and the description of embodiments.

### LIST OF DRAWINGS

Some embodiments will now be described with reference to the accompanying drawings, in which

FIG. 1 and FIG. 2 are simplified structural diagrams illustrating embodiments of a control apparatus; and

FIG. 3 and FIG. 4 are flow charts illustrating embodiments of a method performed by the control apparatus.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

Reference numbers, both in the description of the embodiments and in the claims, serve to illustrate the embodiments with reference to the drawings, without limiting it to these examples only.

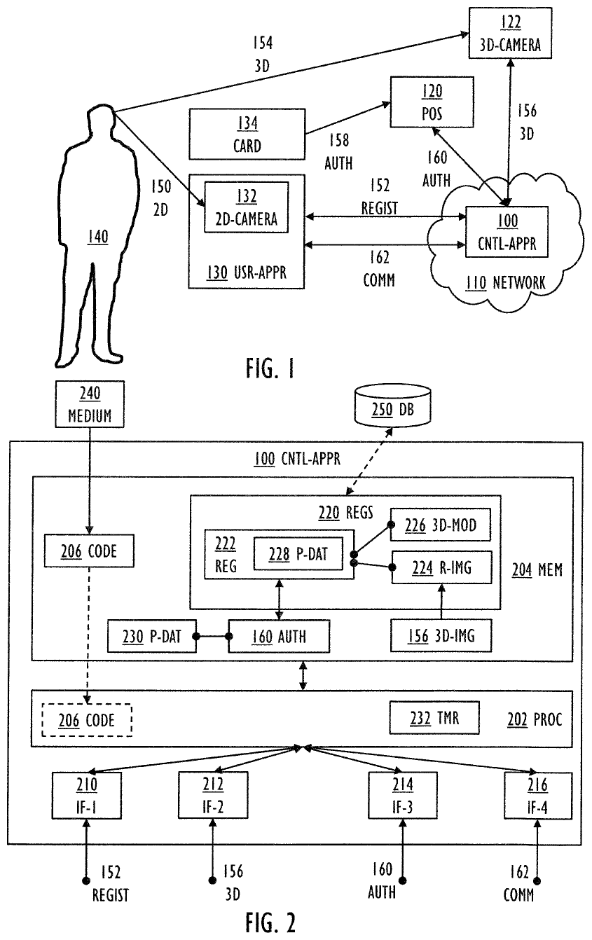

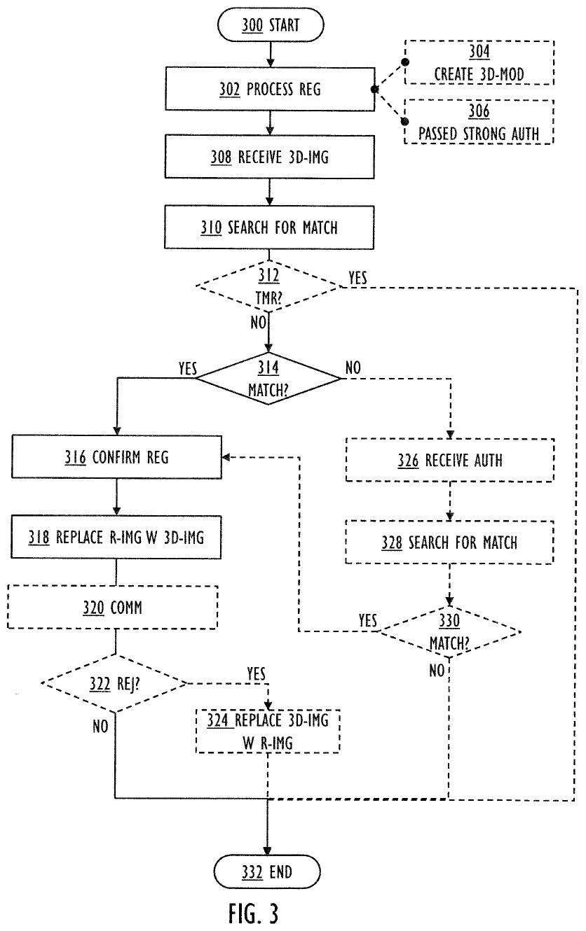

Let us study simultaneously FIG. 1 and FIG. 2, which illustrates embodiments of the control apparatus 100 for controlling a three-dimensional face recognition technique for an authentication of a user, and FIG. 3, which illustrates embodiments of the method for controlling the three-dimensional face recognition technique as an algorithm programmed as computer program code 206 executed by the control apparatus 100 as a special purpose computer.

FIG. 1 illustrates the control apparatus 100 in its general operation environment, whereas FIG. 2 illustrates structural details of the control apparatus 100.

The control apparatus 100 comprises two interfaces 210, 212. These may be separate interfaces 210, 212 as shown in FIG. 2, but, alternatively, they may also utilize the same communication hardware and/or software as well.

The first interface 210 is to process a plurality of initial registrations 220. Each initial registration 222 is made by a user 140 and stored in a storage 250. Each initial registration 222 includes a registration facial image 224 taken with a user apparatus 130. The first interface 210 may comprise a network card or a wireless transceiver to communicate in wired or wireless fashion using a proprietary or standard communication protocol with the local or remote storage 250. The first interface 210 may also utilize other interface technologies such as a bus interface, a software interface (a message interface, a method interface, a sub-routine call interface, etc.), or other hardware/software means enabling communication between the control apparatus 100 and the storage 250. The first interface 210 may also comprise a database query interface enabling search, retrieval, and storing of registration 222 data.

The second interface 212 is to receive a current three-dimensional facial image 156 of a current user 140 taken with an authorized three-dimensional camera 122. The second interface 212 may comprise a network card or a wireless transceiver to communicate in wired or wireless fashion using a proprietary or standard communication protocol with the authorized three-dimensional camera 122. The second interface 212 may also utilize other interface technologies such as a bus interface, a software interface (a message interface, a method interface, a sub-routine call interface, etc.), or other hardware/software means enabling communication between the control apparatus 100 and the authorized three-dimensional camera 122. Note that the second interface 212 may also, instead of direct communication, communicate with a system, such as a point of sale system 120, employing and managing the authorized three-dimensional camera 122.

The point of sale system 120 may be a simple point of sale terminal or it may comprise a number of different hardware and software components. The point of sale system 120 may implement an electronic cash register, and, furthermore possibly also an inventory system, a customer relationship management system, etc.

Accordingly, the control apparatus 100 accesses a storage 250 in order to process the registrations 220. Such electronic data storage 250 may be implemented with appropriate hardware and software as a local or remote database managed by one or more computer servers, but it may be implemented with other suitable storage technologies as well, such as cloud storage.

The user apparatus 130 may be a computer, laptop computer, tablet computer, phablet, mobile phone, smartphone, general-purpose mobile computing device, or some other electronic apparatus comprising or being coupled with a digital camera, or at least comprising required parts such as an optical system and a digital image sensor. The user apparatus 130 may be a general-purpose off-the-shelf computing device, as opposed to a purpose-build proprietary device.

The authorized three-dimensional camera 122 is located in official premises of the organization providing or using the authentication, such as in a service desk accessible by a queue of customers. The service desk may be a counter of a shop such as a store, a market, or a shopping mall, for example. The service desk may also belong to a bank or some other financial organization. The three-dimensional camera 122 is “authorized” in the sense that its operation is strictly controlled for data security and also for image quality (sufficient lighting and of uniform quality, etc.).

The authorized three-dimensional camera 122 may operate according to various techniques, including, but not limited to: projecting structured light onto the face and capturing different parts of the spectrum with one or more sensors, an infrared camera with an infrared projector and an infrared reader, a range camera, and/or a 3D scanner, for example.

In an embodiment, the registration facial image 224 is a two-dimensional image. In an additional or alternative embodiment, the registration facial image 224 has a lower image quality than the current three-dimensional facial image 156. The image quality may be affected by quality of the camera 132, skills of the photographer 140, brightness and evenness of illumination in the scene, and the resulting image may vary in quality as regards to focus, contrast, resolution, geometry, color fidelity and color discrimination, for example. The control apparatus 100 also comprises one or more memories 204 including computer program code 206.

The control apparatus 100 also comprises one or more processors 202 to execute the computer program code 206 to cause the control apparatus 100 to perform the algorithm/method for controlling the three-dimensional face recognition technique for the authentication of the user.

The term ‘processor’ 202 refers to a device that is capable of processing data. Depending on the processing power needed, the control apparatus 100 may comprise several processors 202 such as parallel processors, a multicore processor, or a computing environment that simultaneously utilizes resources from several physical computer units (sometimes these are referred as cloud, fog or virtualized computing environments). When designing the implementation of the processor 202, a person skilled in the art will consider the requirements set for the size and power consumption of the control apparatus 100, the necessary processing capacity, production costs, and production volumes, for example.

A non-exhaustive list of implementation techniques for the processor 202 and the memory 204 includes, but is not limited to: logic components, standard integrated circuits, application-specific integrated circuits (ASIC), system-on-a-chip (SoC), application-specific standard products (ASSP), microprocessors, microcontrollers, digital signal processors, special-purpose computer chips, field-programmable gate arrays (FPGA), and other suitable electronics structures.

The term ‘memory’ 204 refers to a device that is capable of storing data run-time (=working memory) or permanently (=non-volatile memory). The working memory and the non-volatile memory may be implemented by a random-access memory (RAM), dynamic RAM (DRAM), static RAM (SRAM), a flash memory, a solid state disk (SSD), PROM (programmable read-only memory), a suitable semiconductor, or any other means of implementing an electrical computer memory.

The computer program code 206 may be implemented by software. In an embodiment, the software may be written by a suitable programming language, and the resulting executable code may be stored in the memory 204 and executed by the processor 202.

An embodiment provides a computer-readable medium 240 storing the computer program code 206, which, when loaded into the one or more processors 202 and executed by one or more processors 202, causes the one or more processors 202 to perform the algorithm/method, which will be explained with reference to FIG. 3. The computer-readable medium 240 may comprise at least the following: any entity or device capable of carrying the computer program code 206 to the one or more processors 202, a record medium, a computer memory, a read-only memory, an electrical carrier signal, a telecommunications signal, and a software distribution medium. In some jurisdictions, depending on the legislation and the patent practice, the computer-readable medium 240 may not be the telecommunications signal. In an embodiment, the computer-readable medium 240 may be a computer-readable storage medium. In an embodiment, the computer-readable medium 240 may be a non-transitory computer-readable storage medium.

The computer program code 206 implements the algorithm for controlling the three-dimensional face recognition technique. The computer program code 206 may be coded as a computer program (or software) using a programming language, which may be a high-level programming language, such as C, C++, or Java, or a low-level programming language, such as a machine language, or an assembler, for example. The computer program code 206 may be in source code form, object code form, executable file, or in some intermediate form. There are many ways to structure the computer program code 206: the operations may be divided into modules, sub-routines, methods, classes, objects, applets, macros, etc., depending on the software design methodology and the programming language used. In modern programming environments, there are software libraries, i.e. compilations of ready-made functions, which may be utilized by the computer program code 206 for performing a wide variety of standard operations. In addition, an operating system (such as a general-purpose operating system) may provide the computer program code 206 with system services.

In an embodiment, the one or more processors 202 may be implemented as one or more microprocessors implementing functions of a central processing unit (CPU) on an integrated circuit. The CPU is a logic machine executing the computer program code 206. The CPU may comprise a set of registers, an arithmetic logic unit (ALU), and a control unit (CU). The control unit is controlled by a sequence of the computer program code 206 transferred to the CPU from the (working) memory 204. The control unit may contain a number of microinstructions for basic operations. The implementation of the microinstructions may vary, depending on the CPU design.

The control apparatus 100 may be a stand-alone control apparatus 100 as shown in FIG. 1, i.e., the control apparatus 100 is a separate unit, distinct from the point of sale system 120 and the authorized three-dimensional camera 122, for example. However, in an embodiment, at least a part of the structure of the control apparatus 100 may be more or less integrated with another apparatus. In another embodiment, the control apparatus 100 is a networked server apparatus accessible through a wired and/or wireless communication network 110. The networked server apparatus 100 may be a networked computer server, which interoperates with a plurality of user apparatuses 130, and one or more authorized three-dimensional cameras 122, and possibly with one or more point of sale systems 120, according to a client-server architecture, a cloud computing architecture, a peer-to-peer system, or another applicable computing architecture. The control apparatus 100 may be associated with at least one financial system (of a routing/acquiring/issuing bank, for example). A service provider may maintain electronic service provided by the control apparatus 100. The service provider may be an application service provider, which provides the computer-based service with Internet hosting for the customers, sellers and financial institutions. In an embodiment, the service provider is the applicant, OP-Pohjola Group, or some other financial institution.

The communication network 110 may be implemented with a suitable cellular communication technology such as GSM, GPRS, EGPRS, WCDMA, UMTS, 3GPP, IMT, LTE, LTE-A, 3G, 4G, 5G etc., and/or with a suitable non-cellular communication technology such as Bluetooth, Bluetooth Low Energy, Wi-Fi, WLAN, Zigbee, etc., and/or with a suitable wired communication technology such as Ethernet, the Internet, etc.

Let us now study the algorithm/method with reference to FIG. 3.

The method starts in 300 and ends in 332. Note that the method may run as long as required (after the start-up of the control apparatus 100 until switching off) by looping back from operation 318, 322, 324 or 330 back to 302 or 308.

In 302, a plurality of initial registrations are processed. Note that the control apparatus 100 may receive and store the initial registrations 220 into the storage 250, or, another apparatus (not shown in FIG. 1 or FIG. 2) may receive and store the initial registrations 220 into the storage 250, and the control apparatus 100 “processes” these initial registrations 220 such that the data is fetched, updated and searched as necessary.

In an embodiment, each initial registration 222 is accompanied by a passed strong authentication 306 made by the user 140 with the user apparatus 130. In this way, the data security of the initial registration 222 is improved. The strong authentication 306 may utilize any known technique applicable with the user apparatus 130, such as those employed for a payment card, or a (bank) account, for example.

In 308, a current three-dimensional facial image of a current user taken with an authorized three-dimensional camera is received.

In 310, the plurality of registration facial images 224 are searched for a match with the current three-dimensional facial image 156 based on selected facial features.

In an embodiment, the plurality of registration facial images 220 is searched in 310 for the match 314 with the current three-dimensional facial image 156 based on the selected facial features so that a three-dimensional facial model 226, which defines the selected facial features, and which is based on the registration facial image 224, is utilized in the searching in 310. The selected facial features may include measurements of rigid features of the face. The three-dimensional facial model 226 may include a 3D mesh and corresponding texture (or visual details of the skin including lines, pores and actual skin texture) of the face. The search 310 and the match 314 may identify distinct facial features (such as contour of eye sockets, nose and chin).

Next, in 314 a test is performed: if a registration facial image 224 matching with the current three-dimensional facial image 156 is found 314 YES, the initial registration 222 having the matching registration facial image 224 is confirmed in 316, and the registration facial image 224 is replaced with the current three-dimensional facial image 156 in the storage 250 in 318.

In an embodiment, the control apparatus 100 comprises a third interface 214 to receive a strong authentication event 160. The third interface 214 may be implemented in a similar fashion as the first interface 210, and/or the second interface 212.

The strong authentication event 158, 160 may be generated by the use of a payment card 134 of the current user 140. The payment card 134 may communicate with the point of sale system 120, and the current user 140 may enter a PIN (personal identification number) to a user interface of the point of sale system 120, for example.

The payment card 134 may be used by the current user 100 and accepted by the point of sale system 120 to make payments for a trade of good or services. The use of the payment card 134 for the payment may generate transaction data. The payment card 134 may be a credit card or a debit (or bank) card, or any other suitable payment medium, for example. In an embodiment, the payment card 134 may be implemented as a magnetic stripe card, smart card, or a proximity card, or with any other suitable technology, for example. In an embodiment, the payment card 134 may be linked to an account. Naturally, the strong authentication may be performed by other means as well, including, but not limited to a biometric authentication, an authentication utilizing a mobile user apparatus, an authentication associated with a (bank) account, etc. The strong authentication here may refer to a layered authentication relying on two or more authenticators, or to an authentication based on two or more authentication factors (all being mutually independent and at least one factor being non-reusable and non-replicable), for example.

Regarding this embodiment related to the third interface 214, the test performed in 314 is processed as follows: if a registration facial image 224 matching with the current three-dimensional facial image 156 remains undiscovered 314 NO, a current strong authentication event 160 of the current user 140 is received in 326, and the plurality of initial registrations 220 are searched for a match with the current strong authentication event 160 based on personal data 228, 230 of the current user 140 in 328. Also, a further test is made in 330: if an initial registration 222 matching with the current strong authentication event 160 is found 330 YES, the initial registration 222 having the matching personal data 228 is confirmed in 316, and the registration facial image 224 is replaced with the current three-dimensional facial image 156 in the storage 250 in 318.

In an embodiment, the control apparatus 100 comprises a fourth interface 216 to communicate with the user apparatus 130. In 320, the confirming 316 of the initial registration 222 is communicated to the user apparatus 130 of the current user 140. Note that the user apparatus 130 may be same as the one used for the initial registration 222, or another user apparatus used by the current user 140. In response to the communicating 320, an acceptance or a rejection of the confirming 316 may be received from the user apparatus 130 of the current user 140, and if the rejection of the confirming 316 is received 322 YES, the confirming 316 is cancelled, and replacing 324 the current three-dimensional facial image 156 is replaced with the registration facial image 224 in the initial registration 222 in 324. If the acceptance of the confirming 316 is received 322 NO, the confirming 316 remains in force.

In an embodiment, if a registration facial image 224 matching with the current three-dimensional facial image 156 remains undiscovered, the searching 310 is interrupted after a predetermined amount of time has lapsed 312 YES, whereby the initial registration 222 remains unconfirmed. The control apparatus 100 may set a timer 232 (for a predetermined amount of time, such as one minute, two minutes, five minutes, or another suitable time, possibly depending on the customer queue length at the service desk), and if the timer 232 expires, then the initial registration 222 remains unconfirmed and the three-dimensional face recognition technique for the authentication of the current user 140 cannot yet be used.

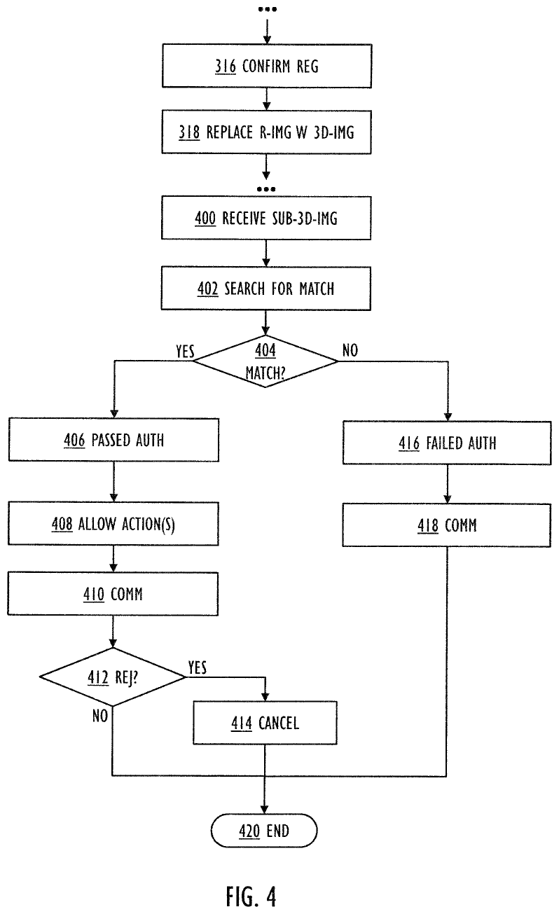

Finally, let us study FIG. 4, which illustrates embodiments relating to the use of the three-dimensional face recognition technique for the authentication of the current user 140 after the confirming 316 and the replacing 318 have succeeded. In 400, a subsequent three-dimensional facial image 156 of the current user 140 taken with an authorized three-dimensional camera 122 is received. In 402, the plurality of stored facial images 224 is searched for a match with the subsequent three-dimensional facial image 156 based on selected facial features. Then a test is performed in 404: if a stored facial image 224 matching with the subsequent three-dimensional facial image 156 is found 404 YES, one or more actions requiring a passed authentication 406 of the current user 140 are allowed in 408, and information regarding the one or more actions and the passed authentication is communicated to the user apparatus 130 of the current user 140 in 410. The one or more actions may include a payment of a trade. If no match is found 404 NO, the authentication failed 416, and this may be communicated 418 to the user apparatus 130 of the current user 140.

In response to the communicating 410, an acceptance or a rejection of the passed authentication 406 may be received from the user apparatus 130 of the current user 140, and if the rejection of the passed authentication 406 is received 412 YES, the passed authentication 406 is cancelled in 414, and also the one or more actions (such as the payment of the trade) may be cancelled. If the acceptance of the passed authentication 406 is received 412 NO, the passed authentication 406 remains in force and also the one or more actions remain accepted.

Even though the invention has been described with reference to one or more embodiments according to the accompanying drawings, it is clear that the invention is not restricted thereto but can be modified in several ways within the scope of the appended claims. All words and expressions should be interpreted broadly, and they are intended to illustrate, not to restrict, the embodiments. It will be obvious to a person skilled in the art that, as technology advances, the inventive concept can be implemented in various ways.

1. A control apparatus for controlling a three-dimensional face recognition technique for an authentication of a user, comprising:
a first interface to process a plurality of initial registrations, each initial registration made by a user, stored in a storage, and including a registration facial image taken with a user apparatus, wherein each initial registration is accompanied by a passed strong authentication made by the user with the user apparatus;
a second interface to receive a current three-dimensional facial image of a current user taken with an authorized three-dimensional camera, which is located in a service desk accessible by a queue of customers in official premises of the organization providing or using the authentication, and whose operation is controlled for data security and image quality;
a third interface to receive a strong authentication event;
one or more memories including computer program code; and
one or more processors to execute the computer program code to cause the control apparatus to perform at least the following:
searching the plurality of registration facial images for a match with the current three-dimensional facial image based on selected facial features; and
if a registration facial image matching with the current three-dimensional facial image is found, confirming the initial registration having the matching registration facial image, and replacing the registration facial image with the current three-dimensional facial image in the storage, or
else if a registration facial image matching with the current three-dimensional facial image remains undiscovered, receiving a current strong authentication event of the current user, searching the plurality of initial registrations for a match with the current strong authentication event based on personal data of the current user, and if an initial registration matching with the current strong authentication event is found, confirming the initial registration having the matching personal data, and replacing the registration facial image with the current three-dimensional facial image in the storage, or
else if a registration facial image matching with the current three-dimensional facial image remains undiscovered, interrupting the searching after a predetermined amount of time has lapsed, whereby the initial registration remains unconfirmed.

2. The control apparatus of claim 1, wherein the registration facial image is a two-dimensional image.

3. The control apparatus of claim 1, wherein the registration facial image has a lower image quality than the current three-dimensional facial image.

4. The control apparatus of claim 1, wherein the control apparatus is caused to perform the following:
searching the plurality of registration facial images for the match with the current three-dimensional facial image based on the selected facial features so that a three-dimensional facial model, which defines the selected facial features, and which is based on the registration facial image, is utilized in the searching.

5. The control apparatus of claim 1, wherein the control apparatus comprises a fourth interface to communicate with a user apparatus, and the control apparatus is caused to perform the following:
communicating the confirming of the initial registration to a user apparatus of the current user.

6. The control apparatus of claim 5, wherein the control apparatus is caused to perform the following:
in response to the communicating, receiving an acceptance or a rejection of the confirming from the user apparatus of the current user; and
if the rejection of the confirming is received, cancelling the confirming, and replacing the current three-dimensional facial image with the registration facial image in the initial registration.

7. The control apparatus of claim 1, wherein the control apparatus is caused to perform the following, after the confirming and the replacing:
receiving a subsequent three-dimensional facial image of the current user taken with an authorized three-dimensional camera;
searching the plurality of stored facial images for a match with the subsequent three-dimensional facial image based on selected facial features; and
if a stored facial image matching with the subsequent three-dimensional facial image is found, allowing one or more actions requiring a passed authentication of the current user, and communicating information regarding the one or more actions and the passed authentication to a user apparatus of the current user.

8. A method for controlling a three-dimensional face recognition technique for an authentication of a user, comprising:
processing a plurality of initial registrations, each initial registration made by a user, stored in a storage, and including a registration facial image taken with a user apparatus, wherein each initial registration is accompanied by a passed strong authentication made by the user with the user apparatus;
receiving a current three-dimensional facial image of a current user taken with an authorized three-dimensional camera, which is located in a service desk accessible by a queue of customers in official premises of the organization providing or using the authentication, and whose operation is controlled for data security and image quality;
searching the plurality of registration facial images for a match with the current three-dimensional facial image based on selected facial features; and
if a registration facial image matching with the current three-dimensional facial image is found, confirming the initial registration having the matching registration facial image, and replacing the registration facial image with the current three-dimensional facial image in the storage, or
else if a registration facial image matching with the current three-dimensional facial image remains undiscovered, receiving a current strong authentication event of the current user, searching the plurality of initial registrations for a match with the current strong authentication event based on personal data of the current user, and if an initial registration matching with the current strong authentication event is found, confirming the initial registration having the matching personal data, and replacing the registration facial image with the current three-dimensional facial image in the storage, or
else if a registration facial image matching with the current three-dimensional facial image remains undiscovered, interrupting the searching after a predetermined amount of time has lapsed, whereby the initial registration remains unconfirmed.

9. A computer-readable medium comprising computer program code, which, when loaded into one or more processors and executed by the one or more processors, causes an apparatus to perform at least the following:
processing a plurality of initial registrations, each initial registration made by a user, stored in a storage, and including a registration facial image taken with a user apparatus, wherein each initial registration is accompanied by a passed strong authentication made by the user with the user apparatus;
receiving a current three-dimensional facial image of a current user taken with an authorized three-dimensional camera, which is located in a service desk accessible by a queue of customers in official premises of the organization providing or using the authentication, and whose operation is controlled for data security and image quality;
searching the plurality of registration facial images for a match with the current three-dimensional facial image based on selected facial features; and
if a registration facial image matching with the current three-dimensional facial image is found, confirming the initial registration having the matching registration facial image, and replacing the registration facial image with the current three-dimensional facial image in the storage, or
else if a registration facial image matching with the current three-dimensional facial image remains undiscovered, receiving a current strong authentication event of the current user, searching the plurality of initial registrations for a match with the current strong authentication event based on personal data of the current user, and if an initial registration matching with the current strong authentication event is found, confirming the initial registration having the matching personal data, and replacing the registration facial image with the current three-dimensional facial image in the storage, or
else if a registration facial image matching with the current three-dimensional facial image remains undiscovered, interrupting the searching after a predetermined amount of time has lapsed, whereby the initial registration remains unconfirmed.
